(19) United States
(12) Patent Application Publication
(10) Pub. No.: US 2023/0068069 A1
(43) Pub. Date: Mar. 2, 2023

(54) TEMPORARY PROBING AGENTS FOR COLLECTING DATA IN A COMPUTING ENVIRONMENT

(71) Applicant: Hewlett-Packard Development Company, L.P., Spring, TX (US)

(72) Inventors: Rafael da Fonte Lopes da Silva, Porto Alegre (BR); Claudio Andre Heckler, Porto Alegre (BR); Carlos Alexandre de Araujo Lima, Porto Alegre (BR); Natalia Machado dos Santos, Porto Alegre (BR)

(73) Assignee: Hewlett-Packard Development Company, L.P., Spring, TX (US)

(21) Appl. No.: 17/791,235

(22) PCT Filed: Feb. 19, 2020
(86) PCT No.: PCT/US2020/018729

§ 371 Date: Jul. 7, 2022

(51) Int. Cl. G06F 21/53

(52) U.S. Cl. CPC G06F 21/53; G06F 2221/034

(57) ABSTRACT

In some examples, a system launches a temporary probing agent in a computing environment within a security boundary, to cause the temporary probing agent to collect data in the computing environment within the security boundary, wherein the temporary probing agent is to terminate in response to a condition indicating completion of data collection by the temporary probing agent. The system provides, to an information consumer, data based on the collected data from the temporary probing agent.

### BACKGROUND

A computing environment can have a security boundary to protect the computing environment from unauthorized access or activities of unauthorized entities. In some examples, the security boundary can be provided by a firewall. In other examples, the security boundary can include a gateway, such as a gateway for containers that implement microservices.

### BRIEF DESCRIPTION OF THE DRAWINGS

Some implementations of the present disclosure are described with respect to the following figures.

FIG. 1 is a block diagram of an arrangement that includes a computing environment within a security boundary, and information consumers that are able to request data from information producers within the computing environment, according to some examples.

FIG. 2 is a message flow diagram of a process according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some cases, an information consumer may desire to access data of a computing environment that is within a security boundary. An “information consumer” can refer to an entity that is outside the security boundary and that intends to consume data from entities within the security boundary. An “entity” can refer to a device (e.g., a desktop computer, a server computer, a notebook computer, a tablet computer, a smartphone, etc.), a program (e.g., an application, an operating system, etc.), a data repository or object, and so forth.

It can be challenging for an information consumer outside a security boundary to access data within the security boundary. The data to be accessed may be available at data channels, data addresses, or other locations that the information consumer may not be able to directly access. For example, the data channels, data addresses, or other locations may not be presented to any entity that is outside the security boundary.

On the other hand, if such data channels, data addresses, or other locations of data were to be exposed to the information consumer outside the security boundary, then the security of the data may be compromised if an information consumer is compromised by malware, if an unauthorized entity has gained access to the information consumer, or if the information consumer impersonates an authorized entity.

In accordance with some implementations of the present disclosure, an orchestrator that straddles a security boundary may be employed to receive requests for data within the security boundary from information consumers outside the security boundary, and to launch temporary probing agents in response to such requests to collect the requested data.

A “security boundary” defines a computing environment, which includes various entities, protected against unauthorized access or operations initiated outside the security boundary. The security boundary can be associated with a security policy that applies to the entities operating within the security boundary, where the security policy specifies rules or criteria that govern who and under what circumstances data of the entities within the security boundary can be accessed.

An “information producer” refers to an entity within the security boundary, where the entity has data that can be conveyed to another interested entity, such as an information consumer.

An “orchestrator” refers to an entity that is able to communicate with entities (such as information consumers) outside the security boundary and entities (such as temporary probing agents) within the security boundary.

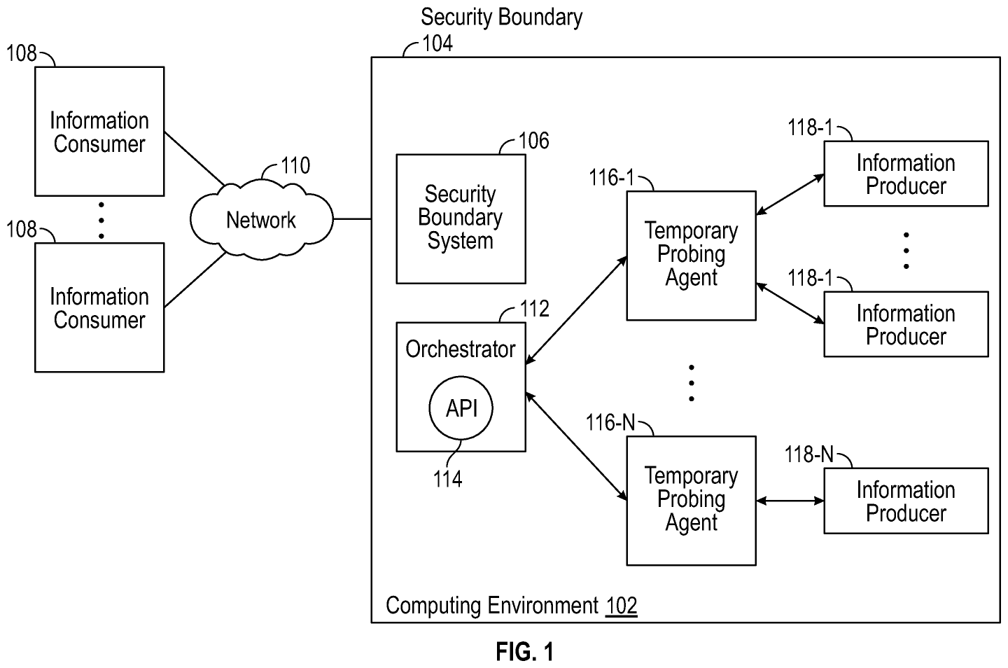

FIG. 1 is a block diagram of an example arrangement that includes a computing environment 102 defined by a security boundary 104. The security boundary 104 is provided by a security boundary system 106, which can be made up of a physical computing device (or multiple physical computing devices) and/or programs that protect the computing environment 102 from unauthorized access or operations. For example, the security boundary system 106 can include a firewall for a network. As another example, the security boundary system 106 can include a gateway of a container in which microservices can be executed. There can be other examples of other types of security boundary systems in other contexts.

Information consumers 108 are able to access the computing environment 102 over a network 110. The network 110 can be implemented using a wired network and/or a wireless network.

An orchestrator 112 is provided which straddles the security boundary 104, such that an entity outside the security boundary 104 is able to communicate with the orchestrator 112, and the orchestrator 112 is able to interact with entities within the security boundary 104. The orchestrator 112 can be part of the security boundary system 106 or can be separate from the security boundary system 106.

In specific examples, the orchestrator 112 can be part of a management system to manage a fleet of devices (e.g., a fleet of printers, computers, communication nodes, storage devices, etc.). As another example, the orchestrator 112 can be part of an ingress controller associated with a container, such as a container to execute microservices. As a further example, the orchestrator 112 can be part of a hub or gateway for a network.

The orchestrator 112 allows data communication through the security boundary system 106 (e.g., a firewall, a gateway of a container, etc.), so that data collected in the computing environment 102 can be provided to an information consumer 108 outside the security boundary 104.

In some examples, the orchestrator 112 presents an orchestrator application programming interface (API) 114, which exposes routines that can be called by an information consumer 108. For example, a routine of the orchestrator API 114 can be called by an information consumer 108 to request data from an information producer (or multiple information producers) in the computing environment 102 within the security boundary 104. The request for data from the information consumer 108 can include an address or identifier of the information producer(s) from which data is to be collected, for example.

The orchestrator API 114 can further include another routine that can be used to deliver collected data (possibly after processing by the orchestrator 112 and/or a temporary agent) to the information consumer 108 that requested the data.

In other examples, instead of using the orchestrator API 114, the orchestrator 112 can present a different interface accessible by the information consumers 108 to request data from the computing environment 102 within the security boundary 104.

In response to a request from an information consumer 108 for data within the security boundary 104, the orchestrator 112 can launch a corresponding temporary probing agent that is able to collect data in the computing environment 102 within the security boundary 104.

In the example of FIG. 1, the orchestrator 112 has launched multiple temporary probing agents 116-1 to 116-N (N≥2). In further examples, the orchestrator 112 can just launch one temporary probing agent.

A “temporary probing agent” refers to an entity that is able to securely collect and process data collected from an information producer, or multiple information producers. In the example of FIG. 1, the temporary probing agent 116-1 collects data from information producers 118-1, and the temporary probing agent 116-N collects data from an information producer 118-N.

More generally, a temporary probing agent 116-i (i=1 to N) is able to collect data from a set of information producers 118-i, where a “set of information producers” can include just one information producer or multiple information producers. The set of information producers from which the temporary probing agent 116-i can be predetermined, or can be dynamically matched to the temporary probing agent 116-i based on matching information producer(s) to criteria associated with the temporary probing agent 116-i.

In some examples, the information producers 118-1 to 118-N in the computing environment 102 can include computers (e.g., desktop computers, laptop computers, server computers, tablet computers, etc.), smartphones, communication nodes (e.g., switches, routers, etc.), storage devices, Internet-of-Things (IoT) devices, programs, microservices, printers, and so forth. Various example types of data that can be collected from information consumers can include health data (e.g., data collected by sensors relating to operations of entities), diagnostic data (data relating to faults or errors), performance data (metric data indicating measured performances of entities), and so forth. In other examples, the data that can be collected from an information producer can include data produced by testing a program or device. For example, the testing can refer to testing of a program, and the data can include a program code coverage metric that indicates how much code of the program was covered by a test. In other examples, other types of data can be collected by a temporary probing agent.

A temporary probing agent has access to location information (or can be configured with location information) indicating locations of data for each information producer for which the temporary probing agent is to collect data. For example, the probing agent may have access or be configured with information identifying data channels of an information producer at which data is available, an address at which data is available, or any other indicator of the location of the information. Once launched, the temporary probing agent is able to use the location information to collect the data from a respective set of information producers. As the temporary probing agent executes, the probing agent uses the location information to discover the target information producers against which to probe, and probes the locations of the set of information producers to collect data.

The location information of data of information producers that is accessible to temporary probing agents is not accessible to entities, such as the information consumers 108, outside the security boundary 104.

The temporary probing agents 116-1 to 116-N can use any of various different techniques to collect data from respective information producers 118-1 to 118-N. For example, data can be collected from an information producer using a Simple Network Management Protocol (SNMP), using a Link Layer Discovery Protocol (LLDP), using an API of a container (e.g., a Kubernetes API), or any other technique, whether standardized, open source, or proprietary.

The temporary probing agent(s) launched by the orchestrator 112 in response to a request from an information consumer 108 can be based on which information producer(s) is (are) identified in the request. As an example, the orchestrator 112 can store (in a storage medium) correlation information that correlates information producers to corresponding temporary probing agents. In response to a request identifying information producer(s), the orchestrator 112 can access the correlation information to determine which temporary probing agent(s) correlate to the identified information producer(s).

As another example, the orchestrator 112 can store information that specifies criteria or rules specifying which temporary probing agents are to be launched to collect respective different types of data.

In some examples, each temporary probing agent 116-i (i=1 to N) terminates in response to a condition indicating completion of data collection by the temporary probing agent 116-i. Terminating a temporary probing agent refers to ceasing execution of the temporary probing agent such that the temporary probing agent is no longer collecting data from any information producer.

A temporary probing agent in some examples can self-terminate based on occurrence of a condition. For example, the temporary probing agent may include a set of predetermined tasks, and the temporary probing agent can terminate once the temporary probing agent has completed the set of predetermined tasks.

In other examples, the orchestrator 112 can instruct a temporary probing agent to terminate in response to a detected condition being satisfied.

By using temporary probing agents to collect data for information consumers outside a security boundary, security is enhanced by reducing the amount of time that each temporary probing agent is actively running. Having multiple temporary probing agents running for extended periods of time even when the temporary probing agents are not actively collecting data may pose a security risk since the temporary probing agents may be discovered and compromised by unauthorized entities. In addition, terminating a temporary probing agent that has completed its task improves the efficiency of utilization of resources of the computing environment.

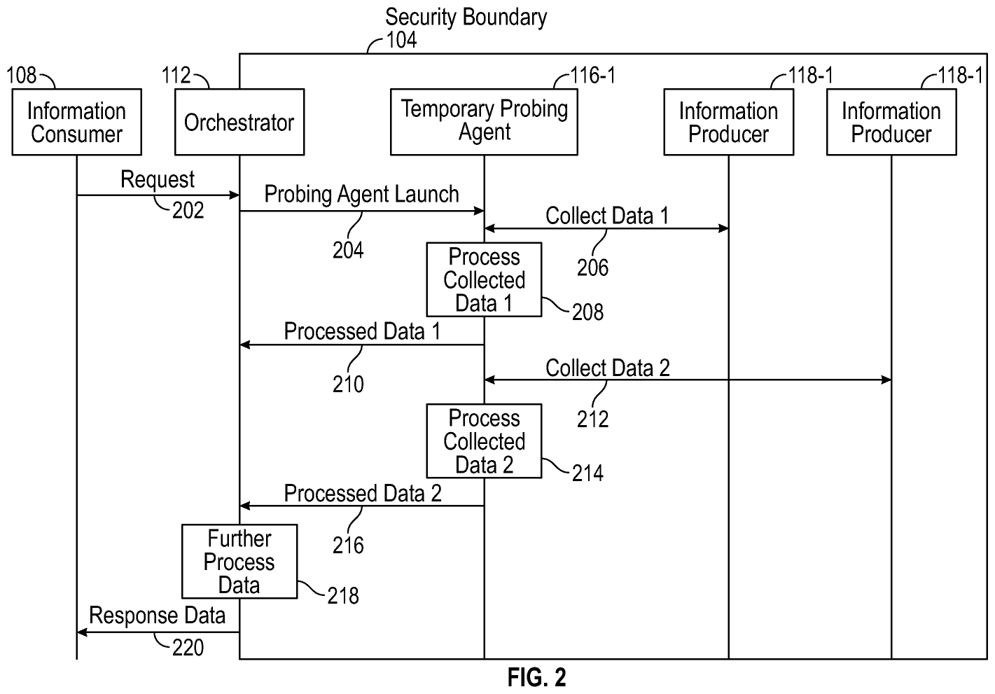

FIG. 2 is a message flow diagram of a process according to some examples. An information consumer 108 sends (at 202) a request for information producer data to the orchestrator 112. For example, the request can include the information consumer 108 invoking a routine of the orchestrator API 114 (FIG. 1), or accessing another type of interface of the orchestrator 112.

The orchestrator 112 responds to the request by launching (at 204) a corresponding temporary probing agent (e.g., 116-1 in the example of FIG. 2) that is within the security boundary 104. For example, the temporary probing agent 116-1 is launched by the orchestrator 112 based on the information producer(s) identified by the request, or based on other information of the request.

The temporary probing agent 116-1 collects data from a set of information producers 118-1. In some examples, the temporary probing agent 116-1 can collect (at 206) data from a first information producer 118-1 by sending a probe command to the first information producer 118-1, which responds with collected data 1.

The temporary probing agent 116-1 applies (at 208) initial processing to collected data 1, and sends (at 210) the resulting processed data 1 to the orchestrator 112. Examples of the initial processing performed by the temporary probing agent 116-1 can include merging multiple instances of data from the first information producer 118-1, aggregating (e.g., averaging, summing, etc.) multiple instances of data from the first information producer 118-1, filtering data from the first information producer 118-1 (e.g., by removing some subset of the data), computing further data based on data from the first information producer 118-1, and so forth.

Similarly, the temporary probing agent 116-1 can collect (at 212) data from a second information producer 118-1 by sending a probe command to the second information producer 118-1, which responds with collected data 2. The temporary probing agent 116-1 applies (at 214) initial processing to collected data 2, and sends (at 216) the resulting processed data 2 to the orchestrator 112.

Although FIG. 2 depicts an example with just two information producers 118-1, in other examples, there can be just a single information producer 118-1, or more than two information producers 118-1.

The orchestrator 112 applies (at 218) further processing of the data returned by the temporary probing agent 116-1, including processed data 1 and processed data 2. The further processing performed by the orchestrator 112 can include merging processed data 1 and processed data 2, aggregating processed data 1 and processed data 2, filtering processed data 1 and processed data 2, redacting information (e.g., sensitive information such as confidential information, personal information, etc.) from processed data 1 and processed data 2, and so forth.

After the further processing, the orchestrator 112 sends (at 220) response data (responsive to the request received at 202) to the information consumer 108, such as by invoking a callback routine of the orchestrator API 114, or by posting a message to a queue monitored by the information consumer 108, or any other suitable method. The response data includes the data resulting from the further processing applied by the orchestrator 112.

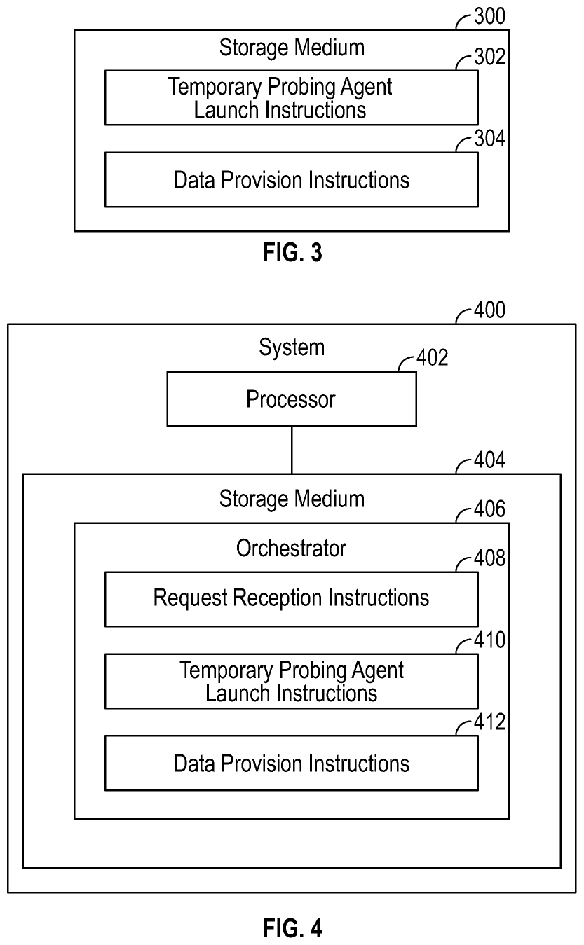

FIG. 3 is a block diagram of a non-transitory machine-readable or computer-readable storage medium 300 storing machine-readable instructions that upon execution cause a system to perform various tasks. The machine-readable instructions can include instructions of the orchestrator 112 and possibly a temporary probing agent 116-i.

The machine-readable instructions include temporary probing agent launch instructions 302 to launch a temporary probing agent in a computing environment within a security boundary. The launching of the temporary probing agent is to cause the temporary probing agent to collect data in the computing environment within the security boundary. The temporary probing agent is to terminate in response to a condition indicating completion of data collection by the temporary probing agent.

The machine-readable instructions further include data provision instructions 304 to provide, to an information consumer, data based on the collected data from the temporary probing agent.

FIG. 4 is a block diagram of an example system 400 according to some implementations of the present disclosure. The system 400 can be implemented with a computer or multiple computers.

The system 400 includes a hardware processor 402 (or multiple hardware processors). A hardware processor can include a microprocessor, a core of a multi-core microprocessor, a microcontroller, a programmable integrated circuit, a programmable gate array, a digital signal processor, or another hardware processing circuit.

The system 400 further includes a non-transitory storage medium 404 storing an orchestrator 406 executable on the hardware processor 402 to perform various tasks. Machine-readable instructions executable on a hardware processor can refer to the instructions executable on a single hardware processor or the instructions executable on multiple hardware processors.

The orchestrator 406 includes request reception instructions 408 to receive a request from an information consumer for data in a computing environment within a security boundary.

The orchestrator 406 includes temporary probing agent launch instructions 410 to launch a temporary probing agent in the computing environment within the security boundary, to cause the temporary probing agent to collect data in the computing environment within the security boundary, where the temporary probing agent is to terminate in response to a condition indicating completion of data collection by the temporary probing agent.

The orchestrator 406 includes data provision instructions 412 to provide, to the information consumer, data based on the collected data from the temporary probing agent.

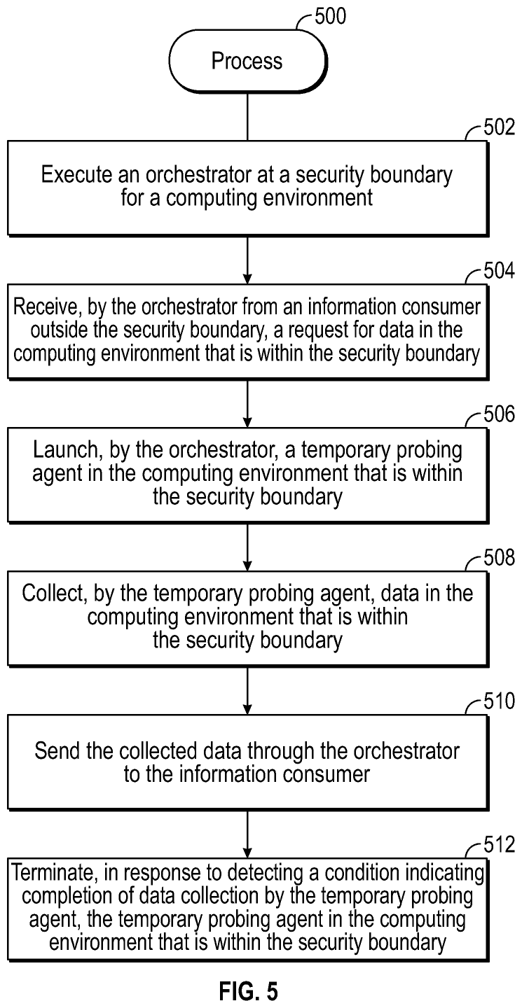

FIG. 5 is a flow diagram of an example process 500 according to some implementations of the present disclosure.

The process 500 includes executing (at 502) an orchestrator (e.g., 112 in FIG. 1 or 406 in FIG. 4) at a security boundary for a computing environment.

The process 500 includes receiving (at 504), by the orchestrator from an information consumer outside the security boundary, a request for data in the computing environment that is within the security boundary.

The process 500 includes launching (at 506), by the orchestrator, a temporary probing agent in the computing environment that is within the security boundary.

The process 500 includes collecting (at 508), by the temporary probing agent, data in the computing environment that is within the security boundary.

The process 500 includes sending (at 510) the collected data through the orchestrator to the information consumer.

The process 500 includes terminating (at 512), in response to detecting a condition indicating completion of data collection by the temporary probing agent, the temporary probing agent in the computing environment that is within the security boundary.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disc (CD) or a digital video disc (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
launch a temporary probing agent in a computing environment within a security boundary, to cause the temporary probing agent to collect data in the computing environment within the security boundary, wherein the temporary probing agent is to terminate in response to a condition indicating completion of data collection by the temporary probing agent; and
provide, to an information consumer, data based on the collected data from the temporary probing agent.

2. The non-transitory machine-readable storage medium of claim 1, wherein the instructions upon execution cause the system to:
receive a request for data from the information consumer,
wherein the launching of the temporary probing agent in the computing environment within the security boundary is responsive to the request.

3. The non-transitory machine-readable storage medium of claim 2, wherein the instructions upon execution cause the system to present an application programming interface (API) comprising a routine accessible by the information consumer to submit the request, and a routine to send the data based on the collected data to the information consumer.

4. The non-transitory machine-readable storage medium of claim 1, wherein the instructions upon execution cause the system to receive the collected data from an information producer in the computing environment within the security boundary, and send the data based on the collected data to the information consumer that is outside of the security boundary.

5. The non-transitory machine-readable storage medium of claim 4, wherein the security boundary is provided by a firewall, and wherein the instructions are part of an orchestrator that allows data communication through the firewall.

6. The non-transitory machine-readable storage medium of claim 4, wherein the security boundary is provided by a gateway of a container, and wherein the instructions are part of an orchestrator that allows data communication from the information producer in the container to an entity outside the container.

7. The non-transitory machine-readable storage medium of claim 6, wherein the collected data includes data based on testing of a program code in the container.

8. The non-transitory machine-readable storage medium of claim 1, wherein the collected data comprises data relating to an operation of a computing device in the computing environment within the security boundary.

9. The non-transitory machine-readable storage medium of claim 8, wherein the collected data comprises health data or diagnostic data of the computing device.

10. The non-transitory machine-readable storage medium of claim 1, wherein the temporary probing agent issues a command to an information producer within the security boundary to obtain the collected data.

11. The non-transitory machine-readable storage medium of claim 1, wherein the temporary probing agent is to terminate in response to the temporary probing agent detecting the condition indicating completion of data collection by the temporary probing agent.

12. A system comprising:
a processor; and
a non-transitory storage medium storing an orchestrator executable on the processor to:
receive a request from an information consumer for data in a computing environment within a security boundary;
in response to the request, launch a temporary probing agent in the computing environment within the security boundary, to cause the temporary probing agent to collect data in the computing environment within the security boundary, wherein the temporary probing agent is to terminate in response to a condition indicating completion of data collection by the temporary probing agent; and
provide, to the information consumer, data based on the collected data from the temporary probing agent.

13. The system of claim 12, wherein the temporary probing agent after the launch is to determine which information producer to probe for collecting data in the computing environment within the security boundary.

14. A method performed by a system comprising a hardware processor, comprising:
executing an orchestrator at a security boundary for a computing environment;
receiving, by the orchestrator from an information consumer outside the security boundary, a request for data in the computing environment that is within the security boundary;
launching, by the orchestrator, a temporary probing agent in the computing environment that is within the security boundary;
collecting, by the temporary probing agent, data in the computing environment that is within the security boundary;
sending the collected data through the orchestrator to the information consumer; and
in response to detecting a condition indicating completion of data collection by the temporary probing agent, terminating the temporary probing agent in the computing environment that is within the security boundary.

15. The method of claim 14, comprising:
applying, by the orchestrator, processing of the collected data from the temporary probing agent to produce processed data; and
sending, by the orchestrator, the processed data to the information consumer in response to the request.
